(19) United States
(12) Patent Application Publication
(10) Pub. No.: US 2019/0388904 A1
(43) Pub. Date: Dec. 26, 2019

(54) AIR CLEAN FILTER, HYBRID AIR CLEAN FILTER AND AIR CLEANER

(71) Applicant: Samsung Electronics Co., Ltd., Suwon-si, Gyeonggi-do (KR)

(72) Inventors: Seiro YUGE, Yokohama-shi (JP); Daisuke FUKUOKA, Yokohama-shi (JP); Manabu TAKEZAWA, Yokohama-shi (JP)

(21) Appl. No.: 16/467,000

(22) PCT Filed: Nov. 30, 2017
(86) PCT No.: PCT/KR2017/013927

§ 371 Date: Jun. 5, 2019

(30) Foreign Application Priority Data
Dec. 5, 2016 (JP) 2016-235977

(51) Int. Cl. B03C 3/155; B01D 46/00; B01D 39/16; B01D 46/52; B03C 3/41; B03C 3/45; B32B 5/02; B32B 5/26; D04H 3/016; D04H 3/018

(52) U.S. Cl. CPC B03C 3/155; D10B 2505/04; B01D 39/1623; B01D 46/521; B03C 3/41; B03C 3/45; B32B 5/022; B32B 5/26; D04H 3/016; D04H 3/018; B03C 2201/04; B03C 2201/06; B03C 2201/10; B01D 2239/0618; B01D 2239/0654; B01D 2239/1233; B01D 2239/1291; B32B 2262/0253; B32B 2307/724; B01D 46/0032

(57) ABSTRACT

A filter media of purifying air by collecting floating particles in the air can achieve high dust collecting efficiency, low pressure loss, and a long life cycle. In an air cleaner, a filter media included in an air cleaning filter and cleaning air is constituted with a resin fiber of a mean fiber diameter of 3.6 μm to 16.5 μm, and a ratio of weight per unit area to the mean fiber diameter of the filter media is from 10×10⁶ g/m³ to 20×10⁶ g/m³.

### CROSS-REFERENCE TO RELATED APPLICATIONS

This application is a 371 National Stage of International Application No. PCT/KR2017/013927, filed Nov. 30, 2017, which claims priority to Japanese Patent Application No. 2016-235977, filed Dec. 5, 2016, the disclosures of which are herein incorporated by reference in their entirety.

### BACKGROUND

### 1. Field

The present disclosure relates to a filter media, an air cleaning filter, a hybrid air cleaning filter, and an air cleaner.

### 2. Description of Related Art

Recently, as the air pollution problem represented by PM2.5 emerges, a need for air cleaners is increasing and air cleaners with a high purification rate are required.

Because the purification rate (purification performance) of an air cleaner depends on the air volume and the dust collecting efficiency of a dust collector, an air cleaning filter used as a dust collector is required to have low pressure loss and high dust collecting efficiency. The pressure loss directly affects the air volume of the air cleaner. The lower pressure loss becomes, the larger air volume is obtained. Therefore, high air cleaning capability can be obtained at low pressure loss and at high dust collecting efficiency.

Meanwhile, the air cleaning filter needs to be replaced by a new one regularly. Therefore, in consideration of the cost or effort, it will be preferable that the air cleaning capability is maintained for a long time, that is, the air cleaning filter has a long life cycle.

Therefore, an air cleaning filter of low pressure loss, high dust collecting efficiency, and a long life cycle is required.

Japanese Laid-open Patent Application No. 2010-142703 discloses an electrostatic filter media constituted with a non-woven fabric laminate of at least two layers, the one layer being a polyolefin-based non-woven fabric, the other layer being a polyester-based non-woven fabric, wherein the polyolefin-based non-woven fabric is an electret-processed non-woven fabric with a density of 0.10 to 0.20 g/cc and the stiffness of the laminated filter media is 100 mg to 1500 mg.

Japanese Laid-open Patent Application No. 2001-347119 discloses an air filter having a plurality of flow paths whose side walls are arranged nearly in parallel to the flow direction of air, the side walls being constituted with a filter media, wherein the side walls defining the adjacent flow paths are formed with a common filter media, at least one partition wall is formed in the flow direction of the flow paths, air blocked by the partition wall passes through the filter media of the side walls to flow to the adjacent flow paths so that the air is filtered, a plurality of partition walls are arranged in one of at least two adjacent flow paths, at least one of partition walls of the other flow path is positioned between the plurality of partition walls of the one flow path, and air passes through the filter media at least two times or more.

Japanese Laid-open Patent Application No. 2011-152520 discloses a laminated filter media resulting from laminating a microfiber non-woven fabric of one or more layers with a reinforcing non-woven fabric of one or more layers, wherein the curl degree of the filter media is 0 mm to 80 mm.

Japanese Laid-open Patent Application No. 2009-106824 discloses a non-woven fabric for air filter, wherein the non-woven fabric is a melt blown non-woven fabric of a single layer mainly made of polyolefin and/or polyester, which is characterized that weight per unit area is 80 g/m² to 140 g/m², the thickness is 0.5 to 1.5 mm, and the single layer has a packing density gradient.

Meanwhile, an air cleaning filter (air filter) used in a household air cleaner requires low pressure loss, high dust collecting efficiency, and a long life cycle.

However, generally, the pressure loss is in a trade-off relationship with the dust collecting efficiency, and also, the pressure loss is in a trade-off relationship with the filter life cycle.

In order to reconcile low pressure loss with high efficiency, a method of reducing the diameter of a fiber is used, and applying a nano fiber being a microfiber is considered. However, oils, gas components, etc., as well as particulate materials, pass through the air cleaning filter. When mixtures of particulate materials and oils are attached on the fiber of a small diameter, the mixtures form sedimentary materials in the form of droplet to close pores. That is, clogging occurs. That is, although initial performance is high, the pressure loss increases so that the air volume deteriorates initially, and the life cycle becomes short.

Also, in order to reconcile low pressure loss with high efficiency, a method of reducing the diameter of the fiber and weight per unit area to lower pressure loss and ensuring dust collecting efficiency by an effect (electrostatic processing) of making the fiber conduct electricity is used. However, the method of reducing the surface area of the fiber greatly influencing the life cycle of the filter by reducing the weight per unit area results in a reduction of the life cycle of the air cleaning filter although it acquires desired performance initially. Also, because the small diameter of the fiber easily causes clogging, the pressure loss increases to lower the air volume, resulting in a reduction of the life cycle.

### SUMMARY

An aspect of the present disclosure is directed to providing a filter media of purifying air by collecting floating particles in the air to achieve high dust collecting efficiency, low pressure loss, and a long life cycle.

### Technical Solution

One aspect of the present disclosure provides an air cleaning filter including: a non-woven fiber for filter on which a filter media cleaning air and a supporting member supporting the filter media are attached, wherein the filter media is constituted with a resin fiber of a mean fiber diameter of 3.6 μm to 16.5 μm, and a ratio of weight per unit area to the mean fiber diameter of the filter media is from 10×10⁶ g/m³ to 20×10⁶ g/m³.

The filter media may be constituted with a resin fiber of a mean fiber diameter of 4.0 μm to 15.0 μm.

The resin fiber constituting the filter media may include at least one inflection point on the outer circumference of the cross section.

The resin fiber constituting the filter media may be a polypropylene fiber having a cross-shaped cross section.

The supporting member may be constituted with a resin fiber, and the resin fiber may be constituted with a long fiber.

The resin fiber constituting the supporting member may include at least one inflection point on the outer circumference of the cross section.

The resin fiber constituting the supporting member may be a polypropylene fiber having a cross-shaped cross section.

Another aspect of the present disclosure provides an air cleaner including: an air cleaning filter including a non-woven fiber for filter on which a filter media cleaning air and a supporting member supporting the filter media are attached; and a fan configured to generate a flow of air to the air cleaning filter, wherein the filter media is constituted with a resin fiber of a mean fiber diameter of 3.6 μm to 16.5 μm, and a ratio of weight per unit area to the mean fiber diameter of the filter media is from 10×10⁶ g/m³ to 20×10⁶ g/m³.

A thickness of a cross section of the filter media may be from 0.4 mm to 1.5 mm at the thinnest area.

The filter media may be constituted with a resin fiber of a mean fiber diameter of 4.0 μm to 15.0 μm.

The resin fiber constituting the filter media may include at least one inflection point on the outer circumference of the cross section.

The resin fiber constituting the filter media may be a polypropylene fiber having a cross-shaped cross section.

The air cleaner may further include a charging portion positioned upstream in a flow direction of air from the air cleaning filter and configured to charge floating particles entering the air cleaning filter.

The charging portion may include a high voltage electrode configured to generate corona discharge, and a counter electrode that is opposite to the high voltage electrode.

The air cleaner may further include a pair of bias electrodes positioned with the non-woven fiber for filter therebetween and configured to apply an electric field to the non-woven filter for filter.

The high voltage electrode may include any one electrode among a wire-shaped electrode, a needle-shaped electrode, and a saw-toothed electrode.

According to the present disclosure, a filter media of purifying air by collecting floating particles in the air can achieve high dust collecting efficiency, low pressure loss, and a long life cycle.

### BRIEF DESCRIPTION OF THE DRAWINGS

FIG. 1 shows an example of an air cleaner to which a first embodiment is applied.

FIG. 2 is a view for describing an air cleaning filter.

FIG. 3A shows a relation between a mean fiber diameter and pressure loss when weight per unit area/mean fiber diameter is 10×10⁶ g/m³.

FIG. 3B shows a relation between a mean fiber diameter and dust collecting efficiency when weight per unit area/mean fiber diameter is 10×10⁶ g/m³.

FIG. 4A shows a relation between a mean fiber diameter and pressure loss when weight per unit area/mean fiber diameter is 15×10⁶ g/m³.

FIG. 4B shows a relation between a mean fiber diameter and dust collecting efficiency when weight per unit area/mean fiber diameter is 15×10⁶ g/m³.

FIG. 5A shows a relation between a mean fiber diameter and pressure loss when weight per unit area/mean fiber diameter is 20×10⁶ g/m³.

FIG. 5B shows a relation between a mean fiber diameter and dust collecting efficiency when weight per unit area/mean fiber diameter is 20×10⁶ g/m³.

FIG. 6A shows a cross-shaped cross section as an example of a modified cross section of a resin fiber.

FIG. 6B shows a flower-shaped cross section as an example of a modified cross section of a resin fiber.

FIG. 6C shows a both-side concave cross section as an example of a modified cross section of a resin fiber.

FIG. 7 shows an example of an air cleaner to which a second embodiment is applied.

FIG. 8A shows a Scanning Electron Microscope (SEM) image of a filter media according to Embodiment 4.

FIG. 8B shows a SEM image of a filter media according to Comparative Example 2.

FIG. 9 is a view for describing a modified example of a hybrid air cleaning filter to which the second embodiment is applied.

FIG. 10 is a view for describing another modified example of a hybrid air cleaning filter to which the second embodiment is applied.

FIG. 11 is a view for describing still another modified example of a hybrid air cleaning filter to which the second embodiment is applied.

FIG. 12 is a view for describing a hybrid air cleaning filter of an air cleaner to which a third embodiment is applied.

### DETAILED DESCRIPTION

Configurations illustrated in the embodiments and the drawings described in the present specification are only the preferred embodiments of the present disclosure, and thus it is to be understood that various modified examples, which may replace the embodiments and the drawings described in the present specification, are possible when filing the present application.

Also, like reference numerals or symbols denoted in the drawings of the present specification represent members or components that perform the substantially same functions.

Also, the terms used in the present specification are used for describing the embodiments of the present disclosure, not for the purpose of limiting and/or restricting the disclosure. It is to be understood that the singular forms “a,” “an,” and “the” include plural referents unless the context clearly dictates otherwise. It will be understood that when the terms “includes,” “comprises,” “including,” and/or “comprising,” when used in this specification, specify the presence of stated features, figures, steps, components, or combination thereof, but do not preclude the presence or addition of one or more other features, figures, steps, components, members, or combinations thereof.

Also, it will be understood that, although the terms first, second, etc. may be used herein to describe various components, these components should not be limited by these terms. These terms are only used to distinguish one component from another. For example, a first component could be termed a second component, and, similarly, a second component could be termed a first component, without departing from the scope of the present disclosure. As used herein, the term “and/or” includes any and all combinations of one or more of associated listed items.

Meanwhile, in the following description, the terms “front end”, “rear end”, “upper portion”, “lower portion”, “upper end”, “lower end”, etc. are defined based on the drawings, and the shapes and positions of the components are not limited by the terms.

Hereinafter, the embodiments of the present disclosure will be described in detail with reference to the accompanying drawings.

### First Embodiment

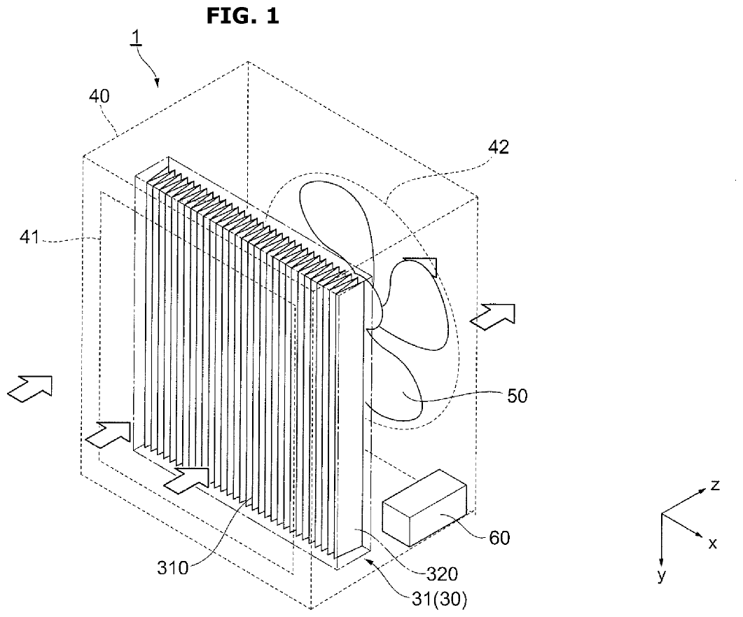

FIG. 1 shows an example of an air cleaner 1 to which a first embodiment is applied.

The air cleaner 1 to which the first embodiment is applied may include an air cleaning filter 31, a housing 40, a fan 50, and a controller 60.

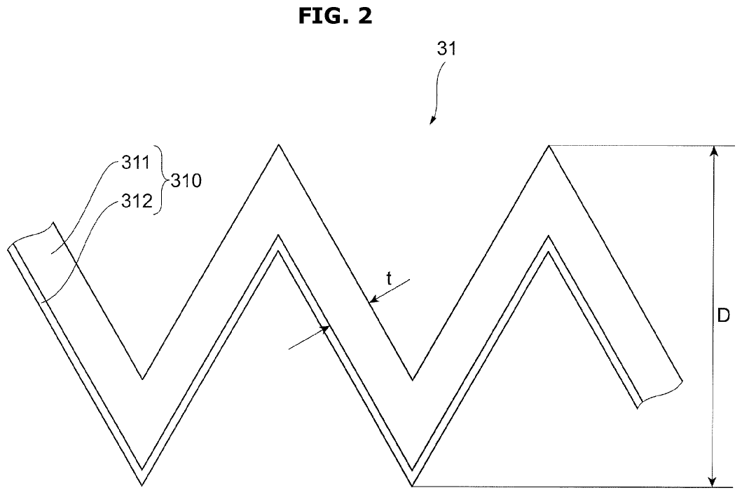

The air cleaning filter 31 may include a non-woven fiber 310 for filter which will be described later, and a frame 320 for fixing the non-woven fiber 310 for filter. A filter media 311 (see FIG. 2 which will be described later) included in the non-woven fiber 310 for filter may collect (absorb) floating particles in the air to purify the air. The frame 320 may be provided for a user to easily install the air cleaning filter 31 in the air cleaner 1 or to easily replace the air cleaning filter 31 with a new one. The frame 320 may be formed in any shape, as long as it supports the non-woven fiber 310 for filter in a grid pattern around and/or on the surface of the non-woven fiber 310 for filter, without preventing air from flowing through the non-woven fiber 310 for filter. The air cleaning filter 31 may constitute a dust collector (capturer) 30.

Also, the air cleaning filter 31 may be referred to as a “filter”.

In FIG. 1, the housing 40 is represented by broken lines to show components, such as the air cleaning filter 31 (dust collector 30), the fan 50, and the controller 60, installed in the inside of the housing 40. Also, the frame 320 of the air cleaning filter 31 is represented by alternated long and short dash lines to show a structure of the non-woven fiber 310 for filter.

The dust collector 30 constituting the air cleaning filter 31 may be an example of air cleaning means, the fan 50 may be an example of ventilation means, and the controller 60 may be an example of control means.

The dust collector 30 may collect (absorb) floating particles.

The housing 40 may accommodate the air cleaning filter 31 (dust collector 30) and the controller 60. In a portion of the housing 40 where the air cleaning filter 31 is positioned, an opening 41 may be formed. Also, the opening 41 may be covered with a mesh (net), a lattice, etc.

The fan 50 may be installed toward another opening 42 formed in the housing 40.

The fan 50 may generate a flow of air (ventilation). A direction of ventilation may be toward the fan 50 from the air cleaning filter 31 (air collector 30) (a direction from left to right in FIG. 1). Also, in FIG. 1, the direction of ventilation is indicated by a white transparent arrow. That is, air may enter the opening 41 adjacent to the air cleaning filter 31 of the housing 40 and then be discharged from the opening 42 adjacent to the fan 50 of the housing 40.

For convenience of description, as shown in FIG. 1, the direction of ventilation is referred to as a z direction and directions that are orthogonal to the z direction are referred to as an x direction and an y direction.

Also, the air cleaner 1 may be positioned in any direction as long as ventilation is not interfered.

FIG. 2 is a view for describing the air cleaning filter 31.

The air cleaning filter 31 may be subject to bending such that a cross-section of the non-woven fiber 310 for filter is in the shape of mountains and valleys. The bending may be pleats bending or the like. The air cleaning filter 31 may have a thickness of D after it is bent.

The non-woven fiber 310 for filter may include the filter media 311 for collecting (capturing) floating particles, and a supporting member 312 for supporting the filter media 311. Because the filter media 311 cannot maintain its shape by itself, the filter media 311 may be attached and supported on the supporting member 312. Accordingly, the dust collecting (capturing) efficiency may depend on the filter media 311.

In the non-woven fiber 310 for filter, the filter media 311 and the supporting member 312 may be constituted with a non-woven fiber. The supporting member 312 may be an elastic non-woven fiber supporting the filter media 311. A thickness of the filter media 311 may bet.

The filter media 311 may be constituted with a resin fiber, such as polyolefin-based polypropylene, polyester-based polyethylene terephthalate, polybutylene terephtalate, polymethylene terephthalate, polyester, polycarbonate, polymethylpentene, a phenol resin, a polystyrene resin, an ethylene propylene copolymer resin, polyether imide (PEI), a polybenzimidazole resin (PBI), etc. Polypropylene among the above-mentioned materials may be preferable. Also, when phosphorous antioxidants and sulfur antioxidants are included in the polyolefin-based fiber, a higher electrostatic effect may be obtained.

The resin fiber may be manufactured by, for example, a spunbond method or a melt blown method. Specifically, the melt blown method may be preferable because it can manufacture a thin resin fiber having a mean fiber diameter of 15 μm or less.

In view of the air cleaner 1, the air volume may contribute greatly to the performance rather than dust collecting efficiency per 1 path, and therefore, deterioration of the air volume has a great influence. Accordingly, it may be important to implement the filter media 311 of high efficiency and low pressure loss causing less deterioration of the air volume without reducing the fiber surface area per unit area.

In the air cleaning filter 31, a mean fiber diameter d_{f}, weight I per unit area, and a fiber surface area s per unit area among parameters of the filter media 311 may satisfy Equation (1) below. Also, the weight I per unit area may be weight per unit area. Also, in Equation (1), σ is a variance of the fiber diameter, and ρ_{f} is a density of the fiber material.

$$S = \frac{4}{( 1 + σ ) {ρ}_{f}} \frac{I}{{d}_{f}} \qquad ( 1 )$$

That is, the fiber surface area s per unit area may greatly depend on a ratio (weight per unit area/mean fiber diameter) of the weight I per unit area to the mean fiber diameter d_{f}. When the filter media 311 is aimed at a long life cycle, it will be preferable that the fiber surface area s per unit area is great, however, increasing the fiber surface area s per unit area may increase pressure loss. Accordingly, a balance between pressure loss and dust collecting efficiency may need to be considered.

In an example of a typical filter media (hereinafter, referred to as a typical product), weight per unit area/mean fiber diameter is about 9.0×10⁶ g/m³.

Accordingly, after weight per unit area/mean fiber diameter is fixed at a value at which a longer life cycle is expected than the typical product, the mean fiber diameter d_{f}, the thickness t of the filter media 311, etc. were examined under the condition. As the result of the examination, a mean fiber diameter (d_{f}) range and a thickness (t) range in which low pressure loss and high collecting efficiency are obtained were found.

The pressure loss of the typical product is 45 Pa to 60 Pa. Pressure loss that is equal to or lower than 30 Pa is preferable to greatly improve the cleaning performance of the air cleaner compared to the typical product.

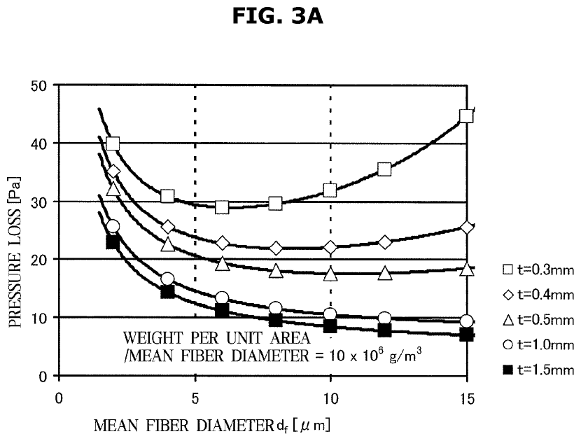

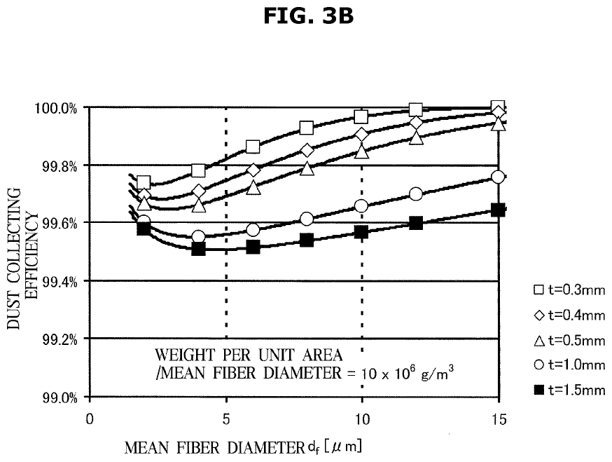

FIG. 3A shows a relation between a mean fiber diameter and pressure loss when weight per unit area/mean fiber diameter is 10×10⁶ g/m³.

FIG. 3B shows a relation between a mean fiber diameter and dust collecting efficiency when weight per unit area/mean fiber diameter is 10×10⁶ g/m³.

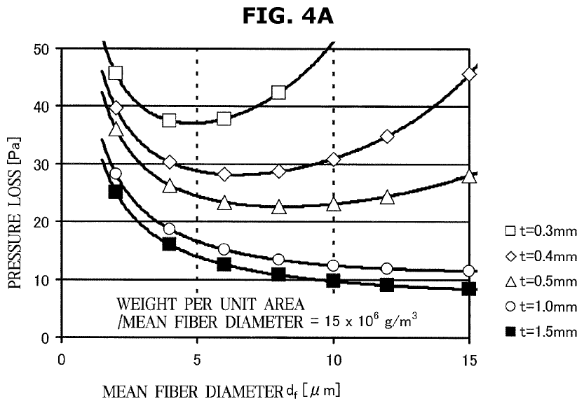

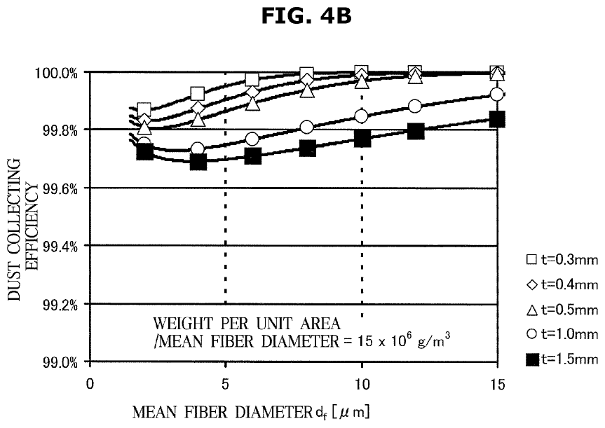

FIG. 4A shows a relation between a mean fiber diameter and pressure loss when weight per unit area/mean fiber diameter is 15×10⁶ g/m³.

FIG. 4B shows a relation between a mean fiber diameter and dust collecting efficiency when weight per unit area/mean fiber diameter is 15×10⁶ g/m³.

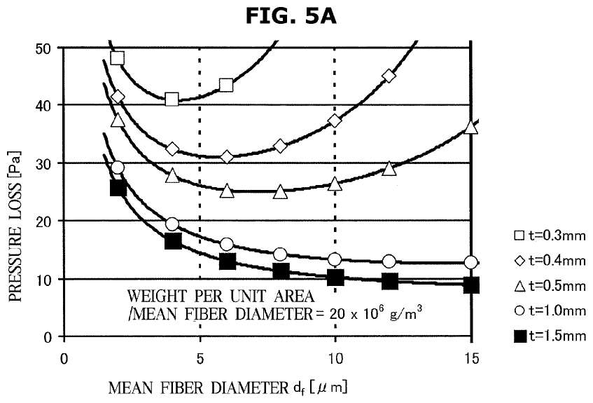

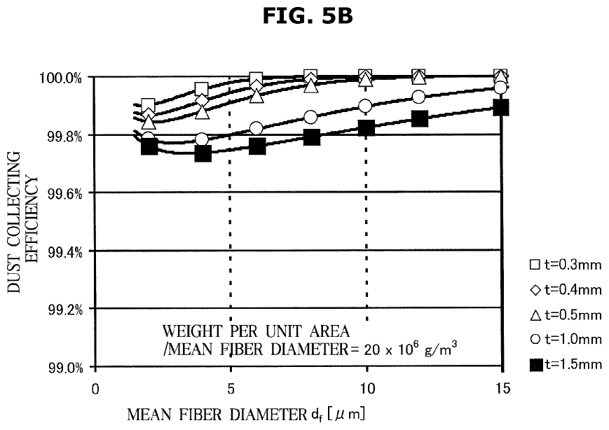

FIG. 5A shows a relation between a mean fiber diameter and pressure loss when weight per unit area/mean fiber diameter is 20×10⁶ g/m³.

FIG. 5B shows a relation between a mean fiber diameter and dust collecting efficiency when weight per unit area/mean fiber diameter is 20×10⁶ g/m³.

In FIGS. 3A, 3B, 4A, 4B, 5A and 5B, the upper drawing shows a relation between the mean fiber diameter d_{f} and pressure loss, and the lower drawing shows a relation between the mean fiber diameter d_{f} and dust collecting efficiency. Also, the thickness t of the filter media 311 is used as a parameter.

As shown in FIGS. 3A, 3B, 4A, 4B, 5A and 5B, in a mean fiber diameter (d_{f}) range of 4.0 μm to 15.0 μm, pressure loss is minimized and dust collecting efficiency of 99% or more is obtained. Also, a case in which pressure loss of about 30 Pa or lower is generated exists in a predetermined range of weight I per unit area.

Also, it was confirmed that when the thickness of the filter media 311 is 0.4 mm or more (preferably, 0.5 mm or more) at the thinnest area, an area in which pressure loss is low with respect to the mean fiber diameter d_{f} is widened so that high performance of the air cleaner 1 is obtained. Also, the thickness t of the filter media 311 may be preferably 1.5 mm or less.

From the above description, it will be understood that the mean fiber diameter d_{f} of the filter media 311 is preferably from 4.0 μm to 15.0 μm and weight per unit area/mean fiber diameter is preferably from 10×10⁶ g/m³ to 20×10⁶ g/m³. However, when the mean fiber diameter d_{f} is included in a range of about 10% differences from the upper limit and the lower limit, the same effect may be obtained. For example, the mean fiber diameter d_{f} may be allowed to be 3.7 μm or 15.5 μm. That is, the mean fiber diameter d_{f} may be preferably from 4.0 μm to 15.0 μm. However, the mean fiber diameter d_{f} may be allowed to be from 3.6 μm to 16.5 μm.

Also, when the mean fiber diameter d_{f} is smaller than 4.0 μm, pressure loss may increase so that dust collecting efficiency is lowered. Meanwhile, when the mean fiber diameter d_{f} is larger than 15.0 μm, pressure loss may increase although dust collecting efficiency is ensured.

Also, when weight per unit area/mean fiber diameter is smaller than 10×10⁶ g/m³, the life cycle may be shortened and the dust collecting efficiency may also be lowered. Meanwhile, when weight per unit area/mean fiber diameter is smaller than 20×10⁶ g/m³, the pressure loss may increase.

Also, when the thickness t of the filter media 311 is thinner than 0.4 mm at the thinnest area, it may be difficult to lower pressure loss. Meanwhile, when the thickness t of the filter media 311 is thicker than 1.5 mm, there may be difficulties in pleats bending.

Also, the resin fiber used in the filter media 311 may be subject to electrostatic processing by well-known technology such as a corona discharge method. Due to the electrostatic processing, the filter media 311 may easily collect (capture, absorb) floating particles.

Also, the resin fiber used in the filter media 311 may have preferably a modified cross section including at least one inflection point on its outer circumference. Also, the supporting member 312 may minimize an increase of pressure loss when the resin fiber used in the supporting member 312 is a long fiber. The resin fiber used in the supporting member 312 may have preferably a modified cross section including at least one inflection point on its outer circumference.

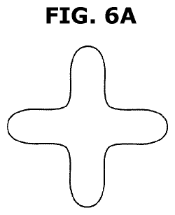

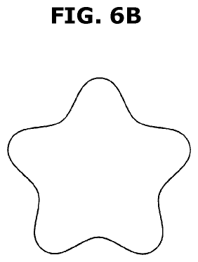

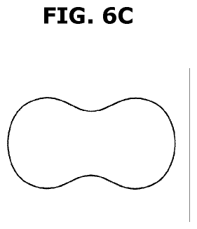

FIG. 6A shows a cross-shaped cross section as an example of a modified cross section of a resin fiber. FIG. 6B shows a flower-shaped cross section as an example of a modified cross section of a resin fiber. FIG. 6C shows a both-side concave cross section as an example of a modified cross section of a resin fiber.

A resin fiber used in the filter media 311 and/or a resin fiber used in the supporting member 312 may have a modified cross section as shown in FIGS. 6A, 6B, and 6C, and preferably include at least one inflection point on its outer circumference. Also, the modified cross section may preferably include at least one inflection point on the circumference, however, the modified cross section may be in any other shape.

Also, the non-woven fiber 310 for filter may be constituted by using the filter media 311 as a single layer or by stacking a thin filter media 311 to multiple layers. In the case of stacking the filter media 311, the total thickness of the stacked filter media 311 may become the thickness t of the filter media 311.

### Embodiment 1

A polypropylene fiber having a mean fiber diameter d_{f} of 5.0 μm, weight I per unit area of 71 g/m², and a thickness t of 0.75 mm is used as the filter media 311. By bonding the filter media 311 with the supporting member 312, the non-woven fiber 310 for filter is prepared. Then, bending (pleats bending) is performed in the shape of mountains and valleys to manufacture the air cleaner 31. In the air cleaning filter 31, a total use area of the filter media 311 is 1.5 m², a thickness D of the filter media 311 is 40 mm, and a projected area onto a surface that is orthogonal to the ventilation direction of the dust collector 30 (air cleaning filter 31) is 0.087 m².

The cross section of the polypropylene fiber of the filter media 311 may be in the shape of a circle, and the cross section of the resin fiber constituting the supporting member 312 may also be in the shape of a circle.

### Comparative Example 1

As the non-woven fiber 310 for filter of the dust collector 30 (air cleaning filter 31), a High-Efficiency Particulate Air (HEPA) filter is used. In Comparison Example 1, the nearly same dust collecting efficiency as in Embodiment 1 is obtained.

### Comparative Example 2

As the non-woven fiber 310 for filter of the dust collector 30 (air cleaning filter 31), an E11 filter is used. In Comparison Example 2, the nearly same pressure loss as in Embodiment 1 is obtained.

After the dust collector 30 using the air cleaning filter 31 is installed in a performance measuring duct, pressure loss and dust collecting efficiency are measured under a condition of wind speed of 1.0 m/s. The pressure loss is a difference between pressure measured at an upstream side (before air enters the air cleaning filter 31) from the air cleaning filter 31 and pressure measured at a downstream side (after air exits the air cleaning filter 31) from the air cleaning filter 31 in the performance measuring duct. The dust collecting efficiency is measured by counting the number of floating particles through a particle counter at the upstream and downstream sides of the air cleaning filter 31 in the performance measuring duct.

Also, the life cycle is evaluated as a total amount of accumulated purification based on an amount of dusts from cigarette smoke, by a test method based on the Chinese national test standard (GB standard) for air cleaners. That is, the life cycle is evaluated as weight (a total amount of accumulated purification) of floating particles collected (captured) in the air cleaning filter 31 until cleaning capability reaches 50 when initial cleaning capability set based on pressure loss and dust collecting efficiency is 100. That is, the heavier weight, the longer life cycle, and the lighter weight, the shorter life cycle.

Results are shown in Table 1. Table 1 shows pressure loss [Pa], dust collecting efficiency [%], life cycle [mg], mean fiber diameter d_{f} [μm], weight per unit area/mean fiber diameter [g/m³], and the thickness (t) [mm] of the filter media 311.

TABLE 1

| | | Comparative | Comparative |
|---|---|---|---|
| | Embodiment 1 | Example 1 | Example 2 |
| Pressure Loss [Pa] | 21 | 47 | 25 |
| Dust Collecting Efficiency | 99.8 | 99.95 | 95 |
| [%] | | | |
| Life Cycle [mg] | About 4300 | About 3600 | About 1400 |
| Mean Fiber Diameter [μm] | 5.0 | 2.46 | 4.0 |
| Weight Per Unit Area/Mean | 14.2 × 10⁶ | 8.3 × 10⁶ | 6.4 × 10⁶ |
| Fiber Diameter [g/m³] | | | |
| Thickness of Filter Media | 0.75 | 0.42 | 0.38 |
| [mm] | | | |

As shown in Table 1, in Embodiment 1, pressure loss is 21 Pa, dust collecting efficiency is 99.8%, and a life cycle is about 4300 mg.

In contrast, in Comparative Example 1 in which the dust collecting efficiency of 99.95% that is similar to that of Embodiment 1 is obtained, the pressure loss is 47 Pa which is two times higher than that of Embodiment 1, and the life cycle is about 3600 mg that is shorter than that of Embodiment 1. Also, in Comparative Example 2 in which the pressure loss of 25 Pa that is similar to that of Embodiment 1 is obtained, the dust collecting efficiency is 95%, and the life cycle is about 1400 mg that is about ⅓ of that of Embodiment 1.

That is, as shown in Comparative Example 1, a typical air cleaning filter has caused high pressure loss although it has high dust collecting efficiency. Also, as shown in Comparative Example 2, another typical air cleaning filter has caused low dust collecting efficiency and a short life cycle although it has low pressure loss.

Compared with Comparative Example 1 and Comparative Example 2, Embodiment 1 achieves low pressure loss, high dust collecting efficiency, and a long life cycle. The reason is because Embodiment 1 has increased the fiber diameter (thick fiber) of the filter media 311, weight per unit area (high weight per unit area), and the thickness of the filter media 311 (large volume). That is, Embodiment 1 achieves low pressure loss, high dust collecting efficiency of 99% or more, and a long life cycle, without increasing the projection area and thickness D (thickness D after bending processing, as shown in FIG. 2) of the dust collector 30 compared to the typical products (Comparison Examples 1 and 2).

### Embodiment 2

As the filter media 311 of Embodiment 1, a polypropylene fiber having a cross-shaped cross section as shown in FIG. 6A is used. The other components are the same as those of Embodiment 1. Results of comparison with Embodiment 1 are represented in Table 2.

TABLE 2

| | Embodiment 2 | Embodiment 1 |
|---|---|---|
| Pressure Loss [Pa] | 22 | 21 |
| Dust Collecting Efficiency [%] | 99.9 | 99.8 |
| Life Cycle [mg] | About 5000 | About 4300 |

As shown in Table 2, Embodiment 2 using a resin fiber having a cross-shaped cross section (modified cross section) as the filter media 311 has improved dust collecting efficiency and increased a life cycle compared with Embodiment 1.

### Embodiment 3

As the supporting member 312 of Embodiment 1, a resin fiber having a cross-shaped cross section as shown in FIG. 6A is used. The other components are the same as those of Embodiment 1. Results of comparison with Embodiment 1 are represented in Table 3.

TABLE 3

| | Embodiment 3 | Embodiment 1 |
|---|---|---|
| Pressure Loss [Pa] | 21 | 21 |
| Dust Collecting Efficiency [%] | 99.85 | 99.8 |
| Life Cycle [mg] | About 4700 | About 4300 |

As shown in Table 3, Embodiment 3 using a resin fiber having a cross-shaped cross section (modified cross section) as the supporting member 312 has improved dust collecting efficiency and increased a life cycle compared with Embodiment 1.

### Second Embodiment

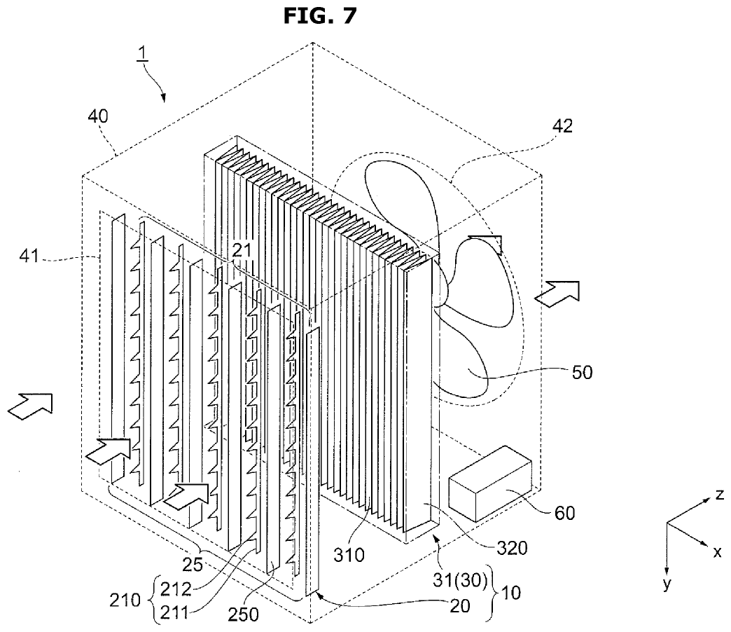

FIG. 7 shows an example of the air cleaner 1 to which a second embodiment is applied.

The air cleaner 1 may include a hybrid air cleaning filter 10, a housing 40, a fan 50, and a controller 60. The hybrid air cleaning filter 10 may include a charging portion 20 and a dust collector (capturer) 30. The dust collector 30 may include an air cleaning filter 31 including a non-woven fiber 310 for filter and a frame 320 fixing the non-woven fiber 310 for filter.

That is, the hybrid air cleaning filter 10 may be a hybrid type using charging technology of charging floating particles and filter technology of collecting (capturing) charged floating particles through a filter media.

In FIG. 7, the housing 40 is represented by broken lines to show components, such as the hybrid air cleaning filter 10 (the charging portion 20 and the dust collector 30), the fan 50, and the controller 60, installed in the inside of the housing 40.

The hybrid air cleaning filter 10 may be another example of air cleaning means.

The charging portion 20 may charge floating particles floating in the air. The dust collector 30 may collect (absorb) the charged floating particles.

The housing 40 may accommodate the hybrid air cleaning filter 10 (the charging portion 20 and the dust collector 30) and the controller 60. In a portion of the housing 40 where the charging portion 20 is positioned, an opening 41 may be formed. Also, the opening 41 may be covered with a mesh (net), a lattice, etc.

The fan 50 may be installed toward another opening 42 formed in the housing 40.

The fan 50 may generate a flow of air (ventilation). A direction of ventilation may be toward the dust collector 30 from the charging portion 20 (a direction from left to right in FIG. 7). Also, in FIG. 7, the direction of ventilation is indicated by a white transparent arrow. That is, air may enter the opening 41 adjacent to the charging portion 20 of the housing 40 and then be discharged from the opening 42 adjacent to the fan 50 of the housing 40 via the charging portion 20 and the dust collector 30. For convenience of description, as shown in FIG. 7, the direction of ventilation is referred to as a z direction and directions that are orthogonal to the z direction are referred to as an x direction and an y direction.

Also, the air cleaner 1 may be positioned in any direction as long as ventilation is not interfered.

Hereinafter, the charging portion 20 will be described in detail. Also, the dust collector 30 is the same as the corresponding one described above in the first embodiment. Therefore, the dust collector 30 is assigned the same reference numeral and a detailed description thereof will be omitted.

(Charging Portion 20)

The charging portion 20 may include a high voltage electrode 21 and a counter electrode 25 that is opposite to the high pressure electrode 21. Also, the high voltage electrode 21 is an electrode to which a high voltage is applied, and also called a discharge electrode because it is an electrode of generating discharge. Also, because the counter electrode 25 may be grounded, the counter electrode 25 is also called a ground electrode.

A high Direct Current (DC) voltage may be applied between the high voltage electrode 21 and the counter electrode 25, for example, wherein the high voltage electrode 21 is positive (+) and the counter electrode 25 is negative (−). Then, corona discharge may occur between the high voltage electrode 21 and the counter electrode 25. Floating particles may be charged by the corona discharge.

Herein, the high voltage electrode 21 may include a plurality of saw-toothed column electrodes 210. Each saw-toothed column electrode 210 may include a connecting portion 211 and a plurality of saw-toothed portions 212 (hereinafter, referred to as saw-toothed electrodes 212) extending from the connecting portion 211. Also, a sharp top of each saw-toothed electrode 212 may be toward the z direction, that is, the wind direction of ventilation.

In FIG. 7, the connecting portion 211 may extend in the y direction. Also, the plurality of saw-toothed column electrodes 210 may be arranged in the x direction.

The counter electrode 25 may include a plurality of plate-shaped electrode plates 250. Each electrode plate 250 may extend in the y direction, and the surface may be positioned in the z direction. Also, the electrode plates 250 may be arranged in the x direction.

The electrode plates 250 and the saw-toothed column electrodes 210 may be arranged alternately such that a saw-toothed column electrode 210 is positioned between two adjacent electrode plates 250.

Also, because an electric field is concentrated on the tops of the saw-toothed electrodes 212, the tops of the saw-toothed electrodes 212 may face the electrode plates 250.

Also, in FIG. 7, 5 saw-toothed column electrodes 210 and 6 electrode plates 250 are shown, however, the numbers of the saw-toothed column electrodes 210 and the electrode plates 250 may change.

The saw-toothed column electrodes 210 and the electrode plates 250 may be made of a conductive metal, such as stainless steel (SUS), copper, etc.

### Embodiment 4

The dust collecting portion 30 of Embodiment 1 may be combined with the charging portion 20 to form the hybrid air cleaning filter 10.

### Comparative Example 3

As the non-woven fiber 310 for filter of the dust collector 30 (air cleaning filter 31), a HEPA filter is used. In Comparative Example 3, dust collecting efficiency that is similar to that of Embodiment 4 is obtained.

### Comparative Example 4

As the non-woven fiber 310 for filter of the dust collector 30 (air cleaning filter 31), an E11 filter is used. In Comparative Example 4, pressure loss that is similar to that of Embodiment 4 is obtained.

After the dust collector 30 and the charging portion 20 of the hybrid air cleaning filter 10 are installed in a performance measuring duct, pressure loss and dust collecting efficiency are measured under a condition of wind speed of 1.0 m/s. The pressure loss is a difference between pressure measured at an upstream side (before air enters the hybrid air cleaning filter 10) from the hybrid air cleaning filter 10 and pressure measured at a downstream side (after air exits the hybrid air cleaning filter 10) from the hybrid air cleaning filter 10 in the performance measuring duct. The dust collecting efficiency is measured by counting the number of floating particles through a particle counter at the upstream and downstream sides of the hybrid air cleaning filter 10 in the performance measuring duct.

Also, the life cycle is evaluated as a total amount of accumulated purification based on an amount of dusts from cigarette smoke, by a test method based on the Chinese national test standard (GB standard) for air cleaners.

That is, the life cycle is evaluated as weight (a total amount of accumulated purification) of floating particles collected (captured) in the air cleaning filter 31 until cleaning capability reaches 50 when initial cleaning capability set based on pressure loss and dust collecting efficiency is 100. That is, the heavier weight, the longer life cycle, and the lighter weight, the shorter life cycle.

Results are shown in Table 4. Table 4 shows pressure loss [Pa], dust collecting efficiency [%], and a life cycle [mg].

TABLE 4

| | | Comparative | Comparative |
|---|---|---|---|
| | Embodiment 4 | Example 3 | Example 4 |
| Pressure Loss [Pa] | 23 | 50 | 28 |
| Dust Collecting Efficiency | 99.9995 | 99.995 | 99.9 |
| [%] | | | |
| Life Cycle [mg] | About 10160 | About 7500 | About 3000 |

As shown in Table 4, in Embodiment 4, the pressure loss is 23 Pa, the dust collecting efficiency is 99.9995%, and the life cycle is about 10160 mg.

In contrast, in Comparative Example 3 in which the dust collecting efficiency of 99.995% that is similar to that of Embodiment 4 is obtained, the pressure loss is 50 Pa which is about two times higher than that of Embodiment 4, and the life cycle is about 7500 mg that is 20% or more shorter than that of Embodiment 4.

Also, in Comparative Example 4 in which the pressure loss of 25 Pa that is similar to that of Embodiment 4 is obtained, the dust collecting efficiency is 99.9%, and the life cycle is about 3000 mg that is ½ or less of that of Embodiment 4.

That is, as shown in Comparative Example 3, a typical air cleaning filter has caused high pressure loss and a short life cycle of the air cleaning filter 31 although it has high dust collecting efficiency. Also, as shown in Comparative Example 4, another typical air cleaning filter has caused low dust collecting efficiency and a short life cycle although it has low pressure loss.

Compared with Comparative Example 3 and Comparative Example 4, Embodiment 4 achieves low pressure loss, high dust collecting efficiency, and a long life cycle.

Also, a life extension effect obtained by combining the dust collector 30 with the charging portion 20 is, in Comparison Examples 3 and 4, about two times with respect to Comparative Examples 1 and 2 described above in Embodiment 1. Meanwhile, Embodiment 4 obtains a life extension effect of two times or more with respect to Embodiment 1 described above in the first embodiment.

The reason is because in Embodiment 4, the pores of the filter media 311 become relatively large by increasing the fiber diameter (thick fiber) of the filter media 311, weight per unit area (high weight per unit area), and the thickness of the filter media 311 (large volume) so that charged floating particles easily enter the inside (downstream in the direction of ventilation) of the filter media 311 and are deposited mainly on the surface of the filter media 311 like when a thin fiber is used to suppress clogging.

That is, Embodiment 4 achieves low pressure loss, high dust collecting efficiency of 99% or more, and a long life cycle, without increasing the projection area and thickness D (thickness D after bending processing, as shown in FIG. 2) of the dust collector 30 compared with the typical products (Comparative Examples 3 and 4).

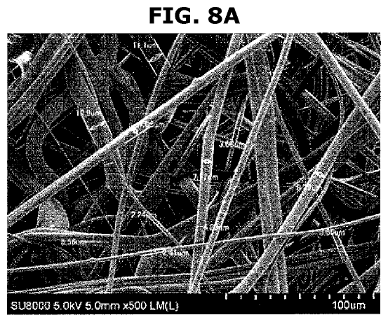

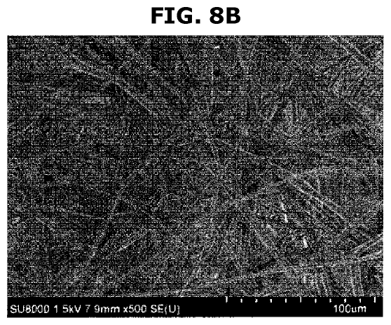

FIG. 8A shows a Scanning Electron Microscope (SEM) image of the filter media 311 according to Embodiment 4, and FIG. 8B shows a SEM image of the filter media 311 according to Comparative Example 2. The filter media 311 of Embodiment 4 is made of a thicker fiber and has a larger volume than the filter media 311 of Comparative Example 2.

### Embodiment 5

As the filter media 311 of Embodiment 4, a polypropylene fiber having a cross-shaped cross section as shown in FIG. 6A is used. The other components are the same as those of Embodiment 4. Results of comparison between Embodiment 5 and Embodiment 4 are represented in Table 5.

TABLE 5

| | Embodiment 5 | Embodiment 4 |
|---|---|---|
| Pressure Loss [Pa] | 24 | 23 |
| Dust Collecting Efficiency [%] | 99.9998 | 99.9995 |
| Life Cycle [mg] | About 12000 | About 10160 |

As shown in Table 5, Embodiment 5 using a resin fiber having a cross-shaped cross section (modified cross section) as the filter media 311 has improved dust collecting efficiency and increased a life cycle compared with Embodiment 4.

### Embodiment 6

As the supporting member 312 of Embodiment 6, a resin fiber having a cross-shaped cross section as shown in FIG. 6A was used. The other components are the same as those of Embodiment 4. Results of comparison between Embodiment 6 and Embodiment 4 are represented in Table 6.

TABLE 6

| | Embodiment 6 | Embodiment 4 |
|---|---|---|
| Pressure Loss [Pa] | 23 | 23 |
| Dust Collecting Efficiency [%] | 99.9997 | 99.9995 |
| Life Cycle [mg] | About 11800 | About 10160 |

As shown in Table 6, Embodiment 6 using a resin fiber having a cross-shaped cross section (modified cross section) as the supporting member 312 improves dust collecting efficiency and increases a life cycle compared with Embodiment 4.

The reason is because particles are charged in advance to be easily absorbed onto the surface of the resin fiber of the supporting member 312 in the hybrid air cleaning filter 10 so that the dust collecting efficiency is improved and the life cycle increases.

Successively, a modified example of the hybrid air cleaning filter 10 to which the second embodiment is applied will be described.

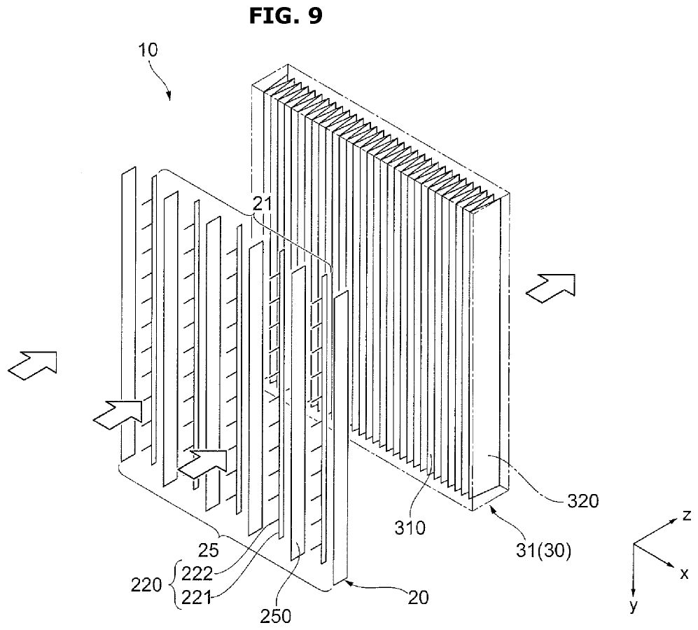

FIG. 9 is a view for describing a modified example of the hybrid air cleaning filter 10 to which the second embodiment is applied. Also, in FIG. 9, the charging portion 20 and the dust collector 30 of the hybrid air cleaning filter 10 in the air cleaner 1 are shown. The other components are the same as those of the second embodiment 2 shown in FIG. 7. Therefore, the components are assigned the same reference numerals, and detailed descriptions thereof will be omitted.

In the modified example, the plurality of saw-toothed column electrodes 210 in the high voltage electrodes 21 of the charging portion 20 shown in FIG. 7 may be replaced by a plurality of needle column electrodes 220. Each needle column electrode 220 may include a connecting portion 221 and a plurality of needle-shaped electrodes 222 (also, referred to as needle electrodes 222) extending from the connecting portion 221.

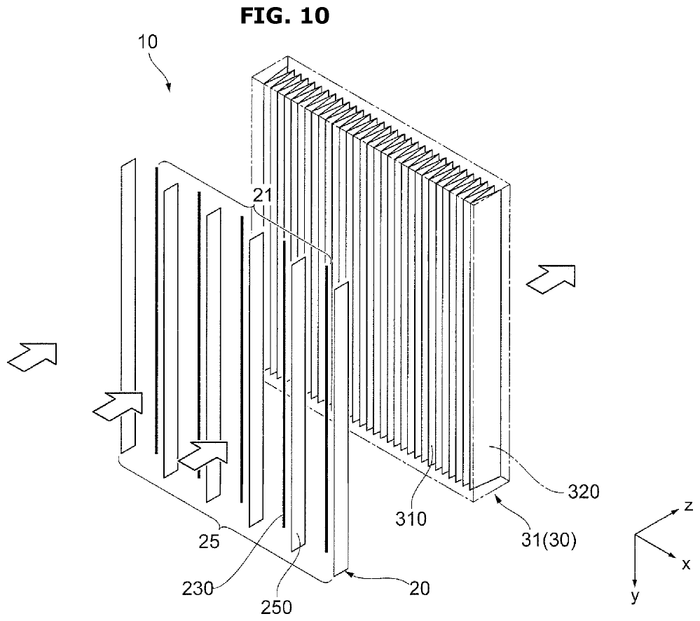

FIG. 10 is a view for describing another modified example of the hybrid air cleaning filter 10 to which the second embodiment is applied. Also, in FIG. 10, the charging portion 20 and the dust collector 30 of the hybrid air cleaning filter 10 in the air cleaner 1 are shown. The other components are the same as those of the second embodiment shown in FIG. 7. Therefore, the components are assigned the same reference numerals, and detailed descriptions thereof will be omitted.

In the modified example, the plurality of saw-toothed column electrodes 210 in the high voltage electrodes 21 of the charging portion 20 shown in FIG. 7 may be replaced by a plurality of wire-shaped electrodes 230 (linear electrodes 230).

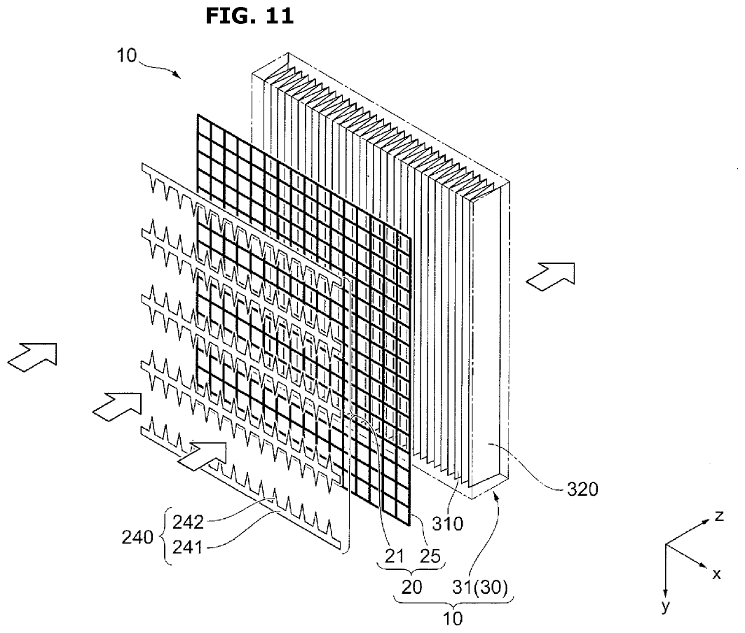

FIG. 11 is a view for describing still another modified example of the hybrid air cleaning filter 10 to which the second embodiment is applied. In FIG. 11, the charging portion 20 and the dust collector 30 of the hybrid air cleaning filter 10 in the air cleaner 1 are shown. The other components are the same as those of the second embodiment 2 shown in FIG. 7. Therefore, the components are assigned the same reference numerals, and detailed descriptions thereof will be omitted.

In the modified example, the plurality of saw-toothed column electrodes 210 in the high voltage electrodes 21 of the charging portion 20 shown in FIG. 7 may be replaced by a plurality of saw-toothed column electrodes 240 including a plurality of saw-toothed electrodes 242 (also referred to as saw-tooth electrodes 242) facing each other in the y direction. Each saw-toothed column electrode 240 may include a connecting portion 241 and a plurality of saw-toothed electrodes 242 extending from the connecting portion 241.

Also, a counter electrode 25 may be formed in the shape of a mesh (net), and positioned downstream in the wind direction of ventilation from the high voltage electrode 21. Through the structure, when a DC high voltage is applied between the high voltage electrode 21 and the counter electrode 25, corona discharge may occur between the high voltage electrode 21 and the counter electrode 25. By the corona discharge, floating particles may be charged.

Also, the saw-toothed electrodes 242 may be the needle electrodes 222 described above.

Also, the saw-toothed electrodes 212 and 242 or the needle electrodes 222 may be arranged by another method. Also, the high voltage electrode 21 and the counter electrode 25 may be arranged by another method. Also, the counter electrode 25 may use another component.

### Third Embodiment

In the third embodiment, the dust collector 30 may include a pair of bias electrodes to apply an electric field to the hybrid air cleaning filter 10.

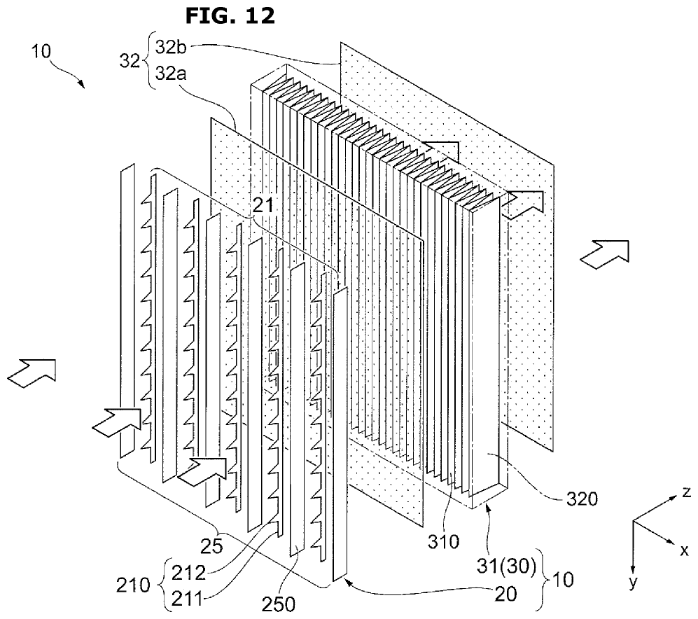

FIG. 12 is a view for describing the hybrid air cleaning filter 10 of the air cleaner 1 to which the third embodiment is applied.

Also, in FIG. 12, the charging portion 20 and the dust collector 30 of the air cleaning filter 10 in the air cleaner 1 are shown. The other components are the same as those of the second embodiment 2 shown in FIG. 7. Therefore, the components are assigned the same reference numerals, and detailed descriptions thereof will be omitted.

The dust collector 30 of the hybrid air cleaning filter 10 may include an air cleaning filter 31 including a bent non-woven fiber 310 for filter, and a pair (a group) of bias electrodes 32 (bias electrodes 32a and 32b) for applying an electric field to the air cleaning filter 31.

For example, when a thickness D of the air cleaning filter 31 including the bent non-woven fiber 310 for filter is 40 mm, a bias voltage of 6 kV to 8 kV may be preferably applied to the bias electrodes 32a and 32b, wherein the bias electrode 32a positioned upstream in the wind direction is negative (−) and the bias electrode 32b positioned downstream in the wind direction is positive (+).

Therefore, charged floating particles may be attracted onto the air cleaning filter 31, thereby improving dust collecting efficiency.

Numerical values denoted in the first embodiment, the second embodiment, and the third embodiment are examples, and they are not limited.

Also, various combinations or modifications may be possible as long as they do not deviate from the purposes of the disclosure.

1. An air cleaning filter comprising:
a non-woven fiber for filter on which a filter media cleaning air and a supporting member supporting the filter media are attached,
wherein the filter media is constituted with a resin fiber of a mean fiber diameter of 3.6 μm to 16.5 μm, and a ratio of weight per unit area to the mean fiber diameter of the filter media is from 10×10⁶ g/m³ to 20×10⁶ g/m³.

2. The air cleaning filter of claim 1, wherein a thickness of a cross section of the filter media is from 0.4 mm to 1.5 mm at a thinnest area of the filter media.

3. The air cleaning filter of claim 1, wherein the filter media is constituted with a resin fiber of a mean fiber diameter of 4.0 μm to 15.0 μm.

4. The air cleaning filter of claim 1, wherein the resin fiber constituting the filter media includes at least one inflection point on an outer circumference of a cross section.

5. The air cleaning filter of claim 1, wherein the resin fiber constituting the filter media is a polypropylene fiber having a cross-shaped cross section.

6. The air cleaning filter of claim 1, wherein the supporting member is constituted with a resin fiber, and the resin fiber is constituted with a long fiber.

7. The air cleaning filter of claim 1, wherein the resin fiber constituting the supporting member includes at least one inflection point on an outer circumference of a cross section.

8. The air cleaning filter of claim 7, wherein the resin fiber constituting the supporting member is a polypropylene fiber having a cross-shaped cross section.

9. An air cleaner comprising:
an air cleaning filter including a non-woven fiber for filter on which a filter media cleaning air and a supporting member supporting the filter media are attached; and
a fan configured to generate a flow of air to the air cleaning filter,
wherein the filter media is constituted with a resin fiber of a mean fiber diameter of 3.6 in to 16.5 μm, and a ratio of weight per unit area to the mean fiber diameter of the filter media is from 10×10⁶ g/m³ to 20×10⁶ g/m³.

10. The air cleaner of claim 9, wherein a thickness of a cross section of the filter media is from 0.4 mm to 1.5 mm at a thinnest area of the filter media.

11. The air cleaner of claim 9, wherein the filter media is constituted with a resin fiber of a mean fiber diameter of 4.0 μm to 15.0 μm.

12. The air cleaner of claim 9, wherein the resin fiber constituting the filter media includes at least one inflection point on an outer circumference of a cross section.

13. The air cleaner of claim 12, wherein the resin fiber constituting the filter media is a polypropylene fiber having a cross-shaped cross section.

14. The air cleaner of claim 9, further comprising a charging portion positioned upstream in a flow direction of air from the air cleaning filter and configured to charge floating particles entering the air cleaning filter.

15. The air cleaner of claim 14, wherein the charging portion comprises a high voltage electrode configured to generate corona discharge, and a counter electrode that is opposite to the high voltage electrode.

16. The air cleaner of claim 14, further comprising a pair of bias electrodes positioned with the non-woven fiber for filter therebetween and configured to apply an electric field to the non-woven filter for filter.

17. The air cleaner of claim 15, wherein the high voltage electrode comprises any one electrode among a wire-shaped electrode, a needle-shaped electrode, and a saw-toothed electrode.
